(19) United States
(12) Patent Application Publication
(10) Pub. No.: US 2025/0291179 A1
(43) Pub. Date: Sep. 18, 2025

(54) ADAPTIVE VISUAL FOCUS AND TRACKING HEADGEAR

(71) Applicant: Aigle Vision LLC, Gainesville, FL (US)

(72) Inventor: Aren Michael Mann, Gainesville, FL (US)

(21) Appl. No.: 19/079,712

(22) Filed: Mar. 14, 2025

Related U.S. Application Data
(60) Provisional application No. 63/565,163, filed on Mar. 14, 2024.

(51) Int. Cl. G02B 27/00; G02B 27/01; G06F 3/01; G06T 7/20; H04N 13/383

(52) U.S. Cl. CPC G02B 27/0093; G02B 27/0172; G02B 27/0179; G06F 3/013; G06T 7/20; H04N 13/383; G02B 2027/0138; G02B 2027/014; G02B 2027/0178; G02B 2027/0187; G06T 2207/10012; G06T 2207/10048

(57) ABSTRACT

A visual processing system may include a first camera system with infrared cameras to capture images of a user's eyes and a second camera system with wide-angle cameras to capture a panoramic field of view. A processor may analyze the eye images to determine a three-dimensional gaze vector, correlate the gaze vector with the panoramic field of view to identify a focus area, and dynamically update the focus area based on changes in the gaze vector. A display device may present augmented visual information within the identified focus area. The first camera system may comprise multiple infrared cameras per eye. The second camera system may provide overlapping fields of view exceeding 180 degrees horizontally and vertically. The system may include additional sensors to detect head movement and generate depth information.

### RELATED APPLICATION

Under provisions of 35 U.S.C. § 119(e), the Applicant claims the benefit of U.S. Provisional Application No. 63/565,163 filed on Mar. 14, 2024, which is incorporated herein by reference.

It is intended that the referenced application may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to head-mounted visual capture devices and systems designed for augmented reality (AR) applications. These devices and systems integrate advanced eye-tracking technologies and scene capture capabilities.

### BACKGROUND

Conventional visual processing systems may struggle to accurately capture and process visual information that reflects a user's true focus and intent based on eye movements. For example, traditional camera-based eye tracking systems may have limitations in precision, especially in varied lighting conditions, with rapid eye movements, or by a limited field of view in scene images and/or pupil camera positions. Thus, the conventional strategy is to use a single camera or sensor to track eye movements and capture the external field of view with another single camera. This often causes problems because the conventional strategy does not provide sufficient data to accurately determine the user's precise area of focus within the full field of view, especially in dynamic environments with rapid visual attention shifts. For example, a single eye tracking camera may not be able to capture subtle eye movements or pupil dilation changes that could indicate shifts in focus. Additionally, a single scene camera may not capture a wide enough field of view to match the user's natural visual range.

Most eye tracking camera systems use one or more eyeball-facing cameras (e.g., a single eyeball-facing camera, one eyeball-facing camera for each eye, or multiple eyeball-facing cameras) calibrated to a single scene camera. This limits the field of view to what a single camera can collect, and it also limits the eye tracking of the full range of motion of the eye.

Furthermore, conventional visual processing systems may struggle to accurately capture and process visual information in dynamic environments with rapidly changing visual stimuli. For example, in augmented reality applications, the user's focus may shift quickly between virtual objects and real-world elements. The conventional strategy of using a single camera or sensor to track eye movements and capture the external field of view may not be able to keep up with these rapid shifts in attention. This often causes problems because the conventional strategy does not provide sufficient temporal resolution to accurately track rapid eye movements or saccades. For example, a system with a low frame rate may miss brief fixations or smooth pursuit movements, leading to inaccurate determination of the user's focus area.

In addition, traditional eye tracking systems may have difficulty maintaining accuracy across different users and usage scenarios. For example, variations in eye shape, size, and movement patterns between individuals can affect the calibration and performance of eye tracking algorithms. Thus, the conventional strategy is to use a one-size-fits-all approach to eye tracking sensor placement and calibration. This often causes problems because the conventional strategy does not account for individual differences in eye physiology and behavior. For example, a system calibrated for an average user may perform poorly for individuals with atypical eye movements or those wearing corrective lenses.

Moreover, existing wearable visual capture devices may be restrictive or unstable when worn for extended periods. For example, conventional eye tracking designs generally fall into various styles of traditional glasses or sunglasses. This direction of product development limits the technology's ability to collect data, in part because the structure of these glasses ends up blocking areas of the visual field that are critical to visual information processing causing discomfort from obstructed vision. Thus, the conventional strategy is to prioritize sensor placement and technical capabilities over ergonomics and user comfort. This often causes problems because the conventional strategy does not consider the impact of device comfort on data quality and user experience. For example, an uncomfortable or unstable device may lead to frequent adjustments by the user, causing misalignment of sensors and introducing errors in eye tracking and scene capture data. Conventional wearable technology also fails to account for the ultra wide field of view that humans are capable of processing, and therefore does not include scene image capture capabilities that collect images as wide as (or even wider than) the typical human field of view.

Accordingly, there is a need for improved visual processing systems that can accurately capture and process visual information reflecting a user's true focus and intent based on eye movements. Conventional strategies often rely on single cameras or sensors for eye tracking and scene capture, which may not provide sufficient data to determine precise areas of focus, especially in dynamic environments with rapid visual attention shifts. This can lead to inaccurate tracking of eye movements, limited field of view capture, and difficulties in maintaining performance across different users and lighting conditions. Additionally, existing wearable visual capture devices may be uncomfortable or unstable when worn for extended periods, potentially causing data quality issues. Furthermore, current systems may struggle with real-time processing and integration of eye tracking and scene capture data, limiting their effectiveness in applications such as augmented reality or assistive technologies.

### Brief Overview

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment for a visual processing system consistent with the present disclosure;

FIG. 2 illustrates a side perspective view of the visual processing system integrated into a wearable device;

FIG. 3 illustrates a rear view of the visual processing system integrated into a wearable device;

FIG. 4 illustrates a top view of the visual processing system integrated into a wearable device;

FIG. 5 is a flow chart of a method for utilizing the visual processing system; and

FIG. 6 is a block diagram of a system including a computing device for performing the method of FIG. 5.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The visual processing system and head-mounted visual capture device disclosed herein may address several technical challenges in accurately capturing and analyzing a user's visual focus and intent. In conventional systems, precisely determining where a user is looking within their full field of view can be difficult, especially in dynamic environments with rapidly changing visual stimuli. The present system aims to solve this problem by integrating advanced eye-tracking capabilities with comprehensive scene capture.

One technical challenge is accurately correlating eye movements with the external visual field in real-time. For example, in an augmented reality (AR) application, the system may need to quickly identify which virtual object a user is focusing on to provide relevant information or enable interactions. The disclosed first camera system, with its multiple eye-tracking sensors positioned substantially equidistantly around each eye's central rotation point, may enable precise tracking of eye movements and pupil characteristics throughout the full range of movement of the user's eyes. This data can then be rapidly processed and mapped to the panoramic field of view captured by the second camera system, allowing for accurate determination of the user's focus area.

Another technical problem addressed by the system is capturing a sufficiently wide field of view to match human peripheral vision while maintaining image quality. In a virtual reality (VR) gaming scenario, for instance, the system may need to render high-quality graphics across the user's entire field of view, including peripheral areas, to create an immersive experience. The second camera system, with its wide-angle lenses and potential for multiple overlapping cameras, may capture a field of view that exceeds the user's natural vision, ensuring comprehensive visual information is available for processing and display.

The system may address challenges in maintaining accurate eye tracking and scene capture in various lighting conditions and during user movement. For example, in a medical training application, a surgeon using the system may need to maintain precise focus on specific areas of a simulated patient while moving their head. The use of infrared sensors in the eye-tracking system may allow for reliable pupil detection even in low-light conditions, while image stabilization features in the scene cameras may ensure clear capture of the external environment despite user movement.

In an industrial setting, such as a factory floor, the system may be used to enhance worker safety and efficiency. The visual processing system may track where workers are looking and identify potential hazards in their field of view. For instance, if a worker's gaze is detected near a piece of dangerous machinery, the system may provide a warning or additional safety information through a connected display.

The system may find applications in cognitive research and attention studies. By precisely tracking eye movements and correlating them with the captured visual field, researchers may gain insights into how individuals process visual information in complex environments. For example, in a study of driver attention, the system may be used to analyze how drivers distribute their visual focus between the road, dashboard instruments, and potential hazards.

The integration of precise eye tracking, comprehensive scene capture, strategic sensor placements and real-time processing may enable more accurate and responsive visual analysis than conventional systems. The modular design of the head-mounted device, with its adjustable components and potential for additional sensors, may allow for customization to specific use cases while maintaining core functionality.

The visual processing system and head-mounted visual capture device disclosed herein may provide several key technical advantages over conventional systems. By utilizing multiple eye-tracking sensors positioned substantially equidistantly from each eye's central rotation point, the system may achieve more precise tracking of eye movements and pupil characteristics compared to systems with fewer or less optimally placed sensors. This enhanced eye tracking, combined with wide-angle scene cameras capturing beyond the user's natural field of view, may allow for more accurate correlation between eye movements and the external visual field. As a result, the system may determine the user's focus area with greater precision, even in dynamic environments with rapidly changing visual stimuli.

The stereoscopic capture capabilities of both the eye-tracking and scene camera systems may enable enhanced depth perception and 3D mapping of the user's visual field. This may be particularly advantageous for applications requiring accurate spatial awareness, such as augmented reality overlays or robotic control systems. The additional depth information may allow for more natural and intuitive interactions with virtual objects or remote systems.

The integration of data collection, synchronization, and processing elements within the housing visor, including the central capture/relay point, may enable real-time analysis of eye movements and scene data. This low-latency processing may be critical for applications requiring immediate feedback or response, such as gaze-based user interfaces or safety systems in industrial settings. The system may be able to rapidly adjust the determined focus area based on dynamic changes in eye movement, providing a more responsive and adaptive user experience.

The wide-angle lenses of the scene cameras, configured to capture a field of view wider than the user's natural vision, may ensure that no relevant visual information is missed. This comprehensive capture may be particularly valuable in applications such as surveillance, sports analysis, or medical training, where peripheral visual cues may be crucial. The overlapping coverage from multiple scene cameras may also provide redundancy and improve overall image quality.

The use of infrared sensors for eye tracking may allow for reliable pupil detection and eye movement tracking even in low-light environments. Additionally, the potential inclusion of high dynamic range (HDR) capabilities in the scene cameras may enable clear image capture across a wide range of lighting conditions. This adaptability may make the system suitable for use in diverse environments, from bright outdoor settings to dimly lit indoor spaces.

The data synchronization module, configured to integrate inputs from both the eye-tracking and scene camera systems, may enable more sophisticated analysis of visual attention and user behavior. This integrated approach may provide valuable insights for fields such as cognitive science, marketing research, or human-computer interaction studies. The potential for machine learning algorithms to improve focus area determination over time may further enhance the system's analytical capabilities.

The combination of precise eye tracking, comprehensive scene capture, and modular design may make the system adaptable to a wide range of applications. From augmented reality and virtual reality to healthcare, education, and industrial training, the system may provide a versatile platform for various visual processing needs. The potential integration with other sensors or input devices may further expand its capabilities for multi-modal interactions.

By addressing these technical challenges and providing these advantages, the visual processing system and head-mounted visual capture device may represent a significant advancement in the field of visual capture and analysis technology. The system's ability to accurately determine user focus, provide comprehensive visual information, and adapt to various environments and applications may open up new possibilities for human-computer interaction, immersive experiences, and visual data analysis.

The present disclosure includes many aspects and features. Moreover, while many aspects and features relate to, and are described in, the context of a visual processing system, embodiments of the present disclosure are not limited to use only in this context.

### I. PLATFORM OVERVIEW

This overview is provided to introduce a selection of concepts in a simplified form that are further described below. This overview is not intended to identify key features or essential features of the claimed subject matter. Nor is this overview intended to be used to limit the claimed subject matter's scope.

The visual processing system described herein may take the form of a high-tech lens that combines eye tracking cameras and wide-angle scene cameras to figure out exactly where a person is looking.

On the inside of the lens, there are multiple small cameras pointed at each of the user's eyes. These eye cameras can detect tiny eye movements and changes in pupil size.

On the outside of the lens, there are wide-angle cameras that capture a very broad view of everything in front of the user—wider than what a person would normally see.

A computer processor in the lens takes the eye movement data from the inside cameras and matches it up with the scene view from the outside cameras. This allows the system to pinpoint precisely what part of the scene the user is focusing on at any given moment.

The visual processing system may be integrated into a headset or helmet designed to be comfortable to wear. For example, the headset may include straps to keep it secure and balanced for added comfort.

This technology could be used for applications such as (but not limited to) providing more immersive virtual and augmented reality experiences, studying how people visually interact with their environment, providing hands-free control of computers or other devices, enhancing vision or providing visual assistance, and/or analyzing visual attention for research or training. The visual processing system combines highly precise eye tracking with comprehensive scene capture, all in a wearable device. This allows for a much more accurate understanding of human visual focus and attention than was previously possible.

Embodiments of the present disclosure may comprise methods, systems, and a computer readable medium comprising, but not limited to, at least one of the following:
A. A First Camera System
B. A Second Camera System
C. A Third Camera System
D. A Processor
E. A Display Device
F. An Illumination System
G. An Inertial Monitoring Unit

Details with regards to each module are provided below. Although modules are disclosed with specific functionality, it should be understood that functionality may be shared between modules, with some functions split between modules, while other functions duplicated by the modules. Furthermore, the name of each module should not be construed as limiting upon the functionality of the module. Moreover, each component disclosed within each module can be considered independently, without the context of the other components within the same module or different modules. Each component may contain functionality defined in other portions of this specification. Each component disclosed for one module may be mixed with the functionality of other modules. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of the operations disclosed with reference to each module. For example, although methods may be described to be performed by a single computing device, it should be understood that, in some embodiments, different operations may be performed by different networked elements in operative communication with the computing device. For example, at least one computing device 600 may be employed in the performance of some or all of the stages disclosed with regard to the methods. Similarly, an apparatus may be employed in the performance of some or all of the stages of the methods. As such, the apparatus may comprise at least those architectural components as found in computing device 600.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in orders that differ from the ones disclosed below. Moreover, various stages may be added or removed without altering or departing from the fundamental scope of the depicted methods and systems disclosed herein.

Consistent with embodiments of the present disclosure, a method may be performed by at least one of the modules disclosed herein. The method may be embodied as, for example, but not limited to, computer instructions which, when executed, perform the method. The method may comprise the following stages:
capturing images of a user's eyes using a plurality of infrared cameras;
capturing a panoramic field of view using a plurality of wide-angle cameras;
analyzing the stereoscopic eye images to determine a three-dimensional gaze vector;
correlating the gaze vector with the panoramic field of view to identify a focus area;
dynamically updating the focus area based on changes in the gaze vector; and
presenting augmented visual information within the identified focus area on a display device.

Although the aforementioned method has been described to be performed by the platform 100, it should be understood that computing device 600 may be used to perform the various stages of the method. Furthermore, in some embodiments, different operations may be performed by different networked elements in operative communication with computing device 600. For example, a plurality of computing devices may be employed in the performance of some or all of the stages in the aforementioned method. Moreover, a plurality of computing devices may be configured much like a single computing device 600. Similarly, an apparatus may be employed in the performance of some or all stages in the method. The apparatus may also be configured much like computing device 600.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. PLATFORM CONFIGURATION

The layout of the various scenarios may differ from embodiment to embodiment but adhere to common design principles. Such design principles may include, for example, the strategic placement of eye-tracking sensors, such that each sensor for a given eye is positioned substantially equidistantly from the central rotation point of the corresponding eye, helping to ensure accurate and responsive tracking of eye movements and pupil characteristics. Additionally, the alignment of scene cameras to coincide with the center of the user's eye rotation capabilities can enhance the correlation between the user's gaze and the captured field of view. The placement of a third camera approximately at eye level may serve to augment depth perception within the visual field. Furthermore, the integration of the eye-tracking system and the scene camera system into a clear lens that can be attached and inserted on or into various headsets, glasses and/or helmets allows for a compact and wearable configuration.

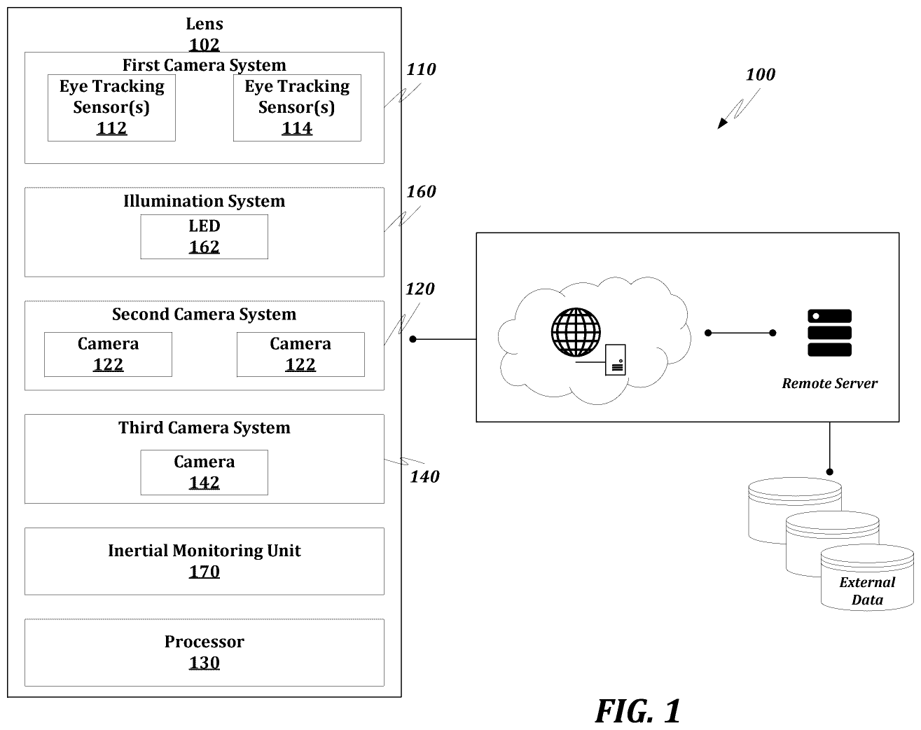

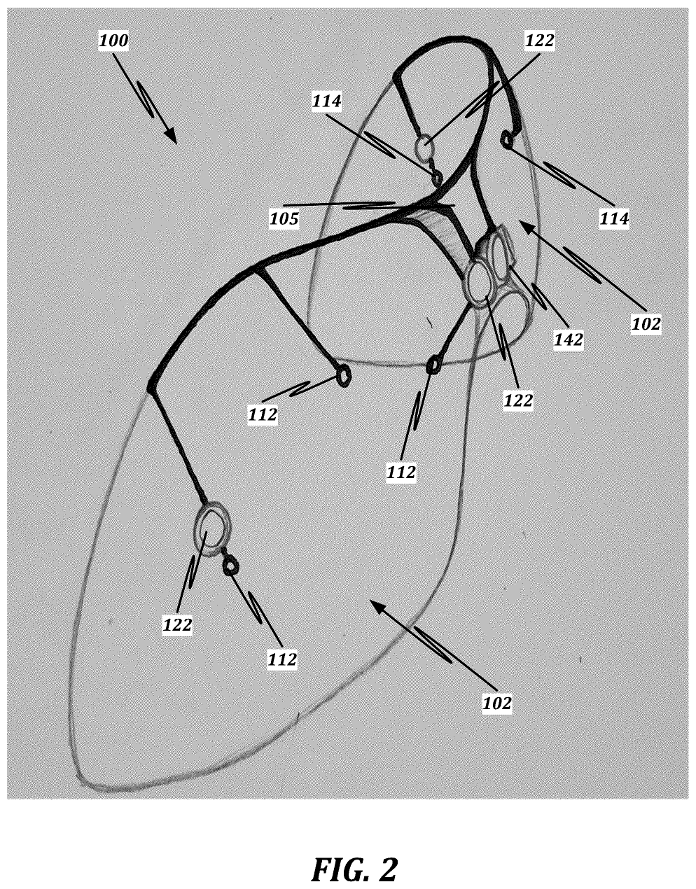

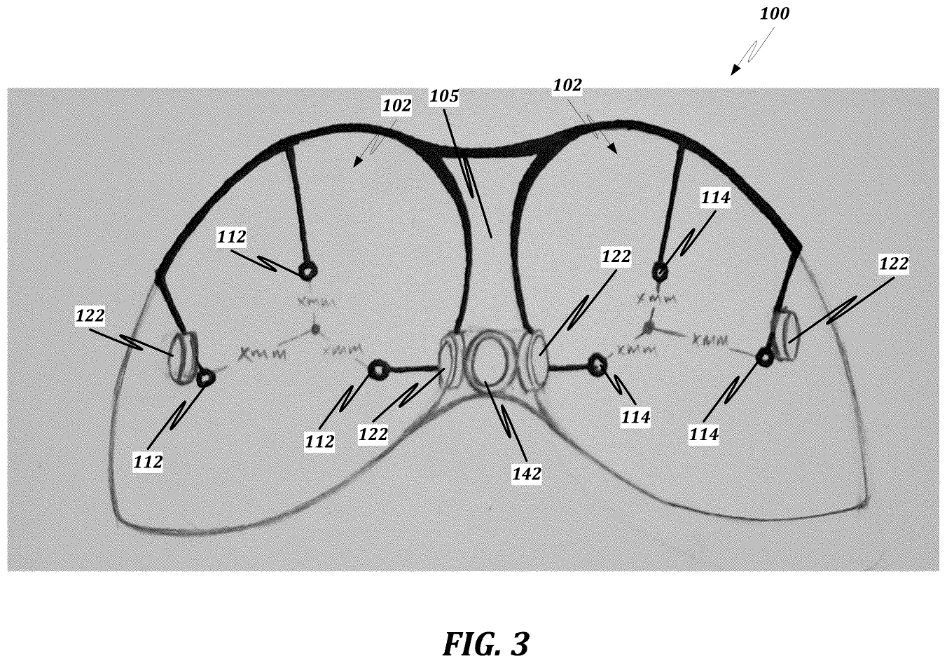

With reference to FIGS. 1-4, the visual processing system 100 may comprise one or more lenses 102 having a first camera system 110, a second camera system 120, and a processor 130. The first camera system 110 may be configured to monitor eye movement and pupil characteristics of a user. The second camera system 120 may be configured to capture an external field of view. The processor 130 may be configured to determine a focus area within the external field of view based on the monitored eye movement.

The first camera system 110 may include two sets of one or more eye-tracking (ET) sensors 112, 114 with each set corresponding to an eye of the user. The ET sensors 112, 114 may be positioned equidistant to a central rotation point of the corresponding eye. This configuration may allow for precise tracking of eye movements and pupil characteristics throughout the full range of motion of each eye. The ET sensors 112, 114 may be capable of detecting both eye movement and pupil dilation to enhance the accuracy of focus area determination. This multi-faceted approach to eye tracking may provide a more nuanced understanding of the user's visual attention and cognitive state.

The first camera system 110 may be capable of capturing images (e.g., stereoscopic images) of the user's eyes for improved eye movement tracking. This stereoscopic capture may provide enhanced depth perception and more accurate gaze estimation.

The second camera system 120 may include at least one scene camera 122 angled to align with the central rotation point of the user's eyes. The lens of the scene camera 122 may be configured to capture a field of view wider than the full field of view of each eye of the user. This may ensure comprehensive visual capture of the user's environment.

In some embodiments, the second camera system 120 may include a plurality of scene cameras, each paired with a corresponding set of ET sensors. These scene cameras may be configured to capture overlapping images to provide a comprehensive field of view.

In some embodiments, the visual processing system 100 may further comprise a third camera system 140 positioned at approximately the user's eye level. The third camera system 140 may enhance depth perception and point of gaze detection accuracy within the captured field of view.

The processor 130 may operate as a central capture/relay point for data processing. This central capture/relay point may facilitate efficient processing and integration of data from the various camera systems. The processor 130 may be further configured to adjust the focus area in real-time based on dynamic changes in the user's eye movement. This capability may allow for responsive and accurate tracking of the user's visual attention.

In some embodiments, the system 100 may include a display device 150. The display device 150 may comprise a transparent display configured to overlay augmented visual information onto the user's view of the real world. The display device 150 may allow the user to see through it while also presenting visual information related to the identified focus area. This configuration enables an augmented reality experience where digital content is seamlessly integrated with the user's natural field of vision.

The display device 150 may utilize technologies such as waveguide optics or holographic optical elements to project images onto the user's view without fully obstructing their vision. The display device 150 may be capable of adjusting visual characteristics (e.g., brightness, opacity, and/or the like) to optimize visibility in different lighting conditions. The display device 150 may incorporate features such as (but not limited to) variable focus to match the perceived depth of presented information with the user's current focal plane.

By overlaying augmented visual information onto the real-world view, the system 100 can provide contextual data, highlight objects of interest, and/or display virtual elements that appear to interact with the physical environment. This augmented view allows for enhanced information delivery while maintaining the user's situational awareness of their surroundings.

The system 100 may optionally include an illumination system 160. The illumination system 160 may comprise a plurality of light sources strategically positioned around the user's eyes to provide optimal illumination for eye tracking. These light sources may include infrared LEDs configured to emit light at wavelengths that are easily detectable by the eye-tracking cameras but not visible or distracting to the user. The illumination system 160 may be designed to create a consistent lighting environment across various ambient conditions, ensuring reliable eye tracking performance in different settings. Additionally or alternatively, the system 160 may incorporate adaptive brightness control to adjust illumination intensity based on environmental factors and user comfort. The illumination system 160 may also feature specialized optics to focus the light precisely on the user's eyes, minimizing scatter and enhancing the contrast of eye features for improved tracking accuracy.

In some embodiments, the system 100 may include an inertial monitoring unit (IMU) 170. The IMU 170 may comprise a combination of accelerometers, gyroscopes, and/or magnetometers to detect and measure the orientation, acceleration, and/or rotational velocity of the system 100. The IMU 170 may be used to track the user's head movements in six degrees of freedom, providing data that can be used to compensate for head motion when determining the user's gaze direction and focus area. This sensor fusion may allow for more accurate and stable eye tracking and scene capture, especially during dynamic head movements. The IMU 170 may also assist in stabilizing the captured scene images and in providing additional context for the user's visual experience.

Accordingly, embodiments of the present disclosure provide a software and hardware platform comprised of a distributed set of computing elements, including, but not limited to:

### A. A First Camera System

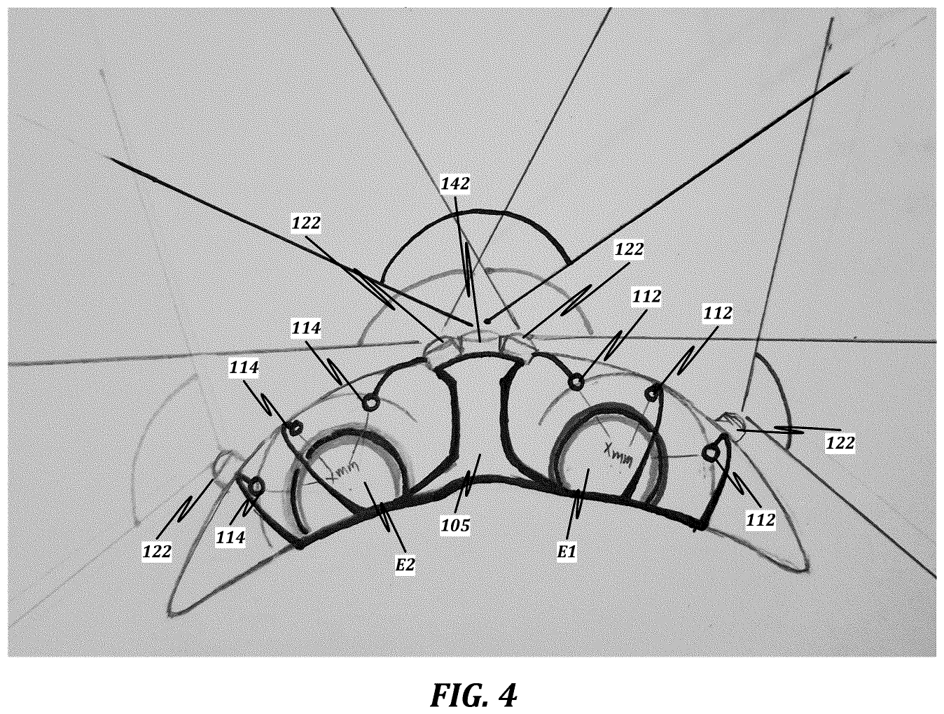

The visual processing system 100 may include a first camera system 110. The first camera system 110, consistent with embodiments of the present disclosure, may comprise a plurality of eye-tracking (ET) sensors 112, 114 for each eye of a user. In some embodiments, the ET sensors 112, 114 may be designed to capture detailed images and/or videos to monitor eye movement and/or pupil characteristics associated with each of the user's eyes. These ET sensors 112, 114 may be placed substantially equidistantly from the central rotation point of the corresponding eye, around the generally common full range of human eye movement. In this way, each set of sensors 112, 114 may be substantially equidistant from a point within the eye to improve accuracy and precision in detecting subtle and/or overt eye movements. In particular, as best shown in FIG. 4, sensors 112 are substantially equidistant from the central rotation point of eye E1, and sensors 114 are substantially equidistant from the central rotation point of eye E2. Additionally or alternatively, one or more (e.g., each) of the ET sensors 112, 114 may be configured to detect pupil dilation characteristics associated with the corresponding eye.

In some embodiments, the first camera system 110 may incorporate stereoscopic image capture technology to improve depth perception and provide enhanced eye movement tracking. This technology may allow the system 110 to generate a three-dimensional view of the corresponding eye, facilitating advanced analysis such as (but not limited to) gaze vector calculations and user engagement metrics.

In further detail, the first camera system 110 may be configured such that the sensors 112, 114 are arranged in a triangular formation around each eye, helping to ensure comprehensive coverage and the ability to accurately track even subtle eye movements and/or changes in pupil size. This triangular formation may allow for the detection of the eye's position in three dimensions, enhancing the precision of gaze detection and/or focus area identification. Each sensor 112, 114 within the system 110 may be calibrated to account for individual variations in eye anatomy, thus improving responsiveness of the system 100 to the particular user's ocular activity. The sensors 112, 114 of the first camera system 110 may be strategically positioned to improve (e.g., maximize) the efficiency of eye tracking. The substantially equidistant placement of the sensors from the central rotation point of each eye may help to reduce parallax error and/or to accurately measure eye movements across different users. This may be important for the detection of vergence and/or version movements of the eyes, which may be useful for determining the point of gaze and/or the relative depth of the focused area within the field of view.

The ET sensors 112, 114 in the first camera system 110 may comprise cameras capable of capturing images at a high frame rate. As one example, the sensors 112, 114 may have frame rates exceeding 180 frames per second. This may help to accurately track rapid eye movements such as saccades. This high frame rate may allow for the detection of micro-saccades and/or other subtle eye movements that may be indicative of cognitive processes and/or visual attention.

Each sensor 112, 114 in the first camera system 110 may include a high-resolution image sensor. As one non-limiting example, each sensor 112, 114 may have a resolution of 1 megapixel or higher. The high resolutions of the sensors may help to capture fine details of the eye's structure and/or movement. The sensors 112, 114 may incorporate advanced optics to provide a shallow depth of field. This helps to ensure that the eye remains in focus even with movements of the device relative to the user's head.

The first camera system 110 may include hardware and/or software for image processing. For example, the image processing may enhance the quality of captured eye images. The image processing techniques employed may include noise reduction, contrast enhancement, and/or edge detection to improve the accuracy of pupil and iris detection. The system 110 may also employ artificial intelligence and/or machine learning algorithms to adapt to a particular user's eye characteristics over time, improving tracking accuracy with continued use.

In some embodiments, the first camera system 110 may include one or more additional sensors to complement the eye-tracking sensors 112, 114. These additional sensors may include accelerometers or gyroscopes to detect head movement, which can be used to compensate for device motion and maintain accurate eye tracking. The system 100 may incorporate proximity sensors to detect when the device is being worn and activate or deactivate the eye-tracking system accordingly.

The first camera system 110 may be designed with power efficiency in mind, utilizing low-power components and intelligent power management to extend battery life in portable applications. This may include features such as selective activation of cameras based on detected user activity or gaze direction.

The sensors 112, 114 of the first camera system 110 may be integrated into a lens for use with a system 100 in a way that reduces or minimizes the visibility and/or impact of the sensors on the user's field of view. This may involve the use of miniaturized components and clever placement to ensure that the sensors do not obstruct the user's vision or cause discomfort during extended wear.

### B. A Second Camera System

The visual processing system 100 may include a second camera system 120. The second camera system 120 may comprise a plurality of cameras 122, which may include one or more wide-angle cameras. The plurality of cameras 122 may be configured to capture a panoramic field of view. As one example shown in FIG. 4, each camera 122 may have a panoramic field of view of 114 degrees horizontally and/or vertically. The wide-angle cameras 122 of the second camera system 120 may be positioned on the exterior side of a wearable frame or embedded within a lens to capture the environment in front of the user.

One or more (e.g., each) camera 122 in the second camera system 120 may be equipped with a wide-angle lens to facilitate capturing a broad field of view. The lens may be configured to have a field of view that extends beyond that of a standard lens, allowing each camera 122 to capture a wider perspective of the scene.

The cameras 122 of the second camera system 120 may be arranged in an arcuate, semicircular, or circular pattern on the exterior of the wearable hosing visor 150. For example, the cameras may have a field of view in the range of 120-180 degrees. This layout may be designed to increase or maximize the panoramic capture of the environment, allowing for a comprehensive view that closely mimics or exceeds the natural human field of vision.

The second camera system 120 may include multiple cameras 122 having overlapping fields of view to provide comprehensive capture of the visual scene. The overlapping fields of view from the different cameras 122 may cover a full 180 degrees or more in the horizontal and/or vertical planes. This overlap in coverage of the fields of view may ensure a seamless and complete visual representation of the environment.

The cameras 122 of the second camera system 120 may be high-resolution cameras capable of capturing detailed scene information. Each camera 122 may be configured to capture high-definition video images to provide rich visual data of the user's surroundings.

In some embodiments, the cameras 122 may include image stabilization features. The image stabilization features may help to capture clear images while the user is in motion, counteracting or mitigating any motion-induced blur.

The second camera system 120 may include one or more cameras with high dynamic range (HDR) image capture capabilities. The HDR image capture may allow the system 120 to capture clear scene images under varying lighting conditions, from bright sunlight to low-light environments.

### C. A Third Camera System

In some embodiments, the visual processing system 100 may optionally include a third camera system 140. The third camera system 140 may be positioned at approximately eye level relative to the user. The third camera system 140 may be configured to enhance depth perception and point of gaze detection accuracy within the captured field of view.

The third camera system 140 may comprise one or more cameras 142. In some embodiments, the third camera system 140 may include a single camera 142 positioned centrally at approximately eye level (e.g., at eye level, just below eye-level, or just above eye level). In other embodiments, the third camera system 140 may include two cameras 142 positioned at approximately eye level (e.g., one near each eye). In some embodiments, the one or more cameras 142 may have a wide field of view, in the range of 120-180 degrees. In other embodiments, the camera 142 may have a more narrow field of view of approximately 100 degrees.

In embodiments that utilize two cameras 142, the cameras of the third camera system 140 may be angled slightly inward (e.g., toward the center of the user's field of view). This inward angle may help align the captured images with the user's natural gaze direction.

The third camera system 140 may utilize high resolution image sensors in the one or more cameras 142 to capture detailed depth information. The one or more cameras 142 may incorporate features such as (but not limited to) autofocus and/or image stabilization to maintain image clarity as the user moves.

In some embodiments, the third camera system 140 may employ stereo vision techniques to generate 3D depth maps of the scene. The depth information from the third camera system 140 may be combined with eye tracking data from the first camera system 110 to more accurately determine the user's point of focus in three-dimensional space.

The third camera system 140 may be integrated into the housing visor 150 along with the first and second camera systems 110, 120. Positioning of the third camera system 140 may help minimize or reduce obstruction of the user's field of view while still capturing useful depth data.

### D. A Processor

The visual processing system 100 may include a processor 130. In some embodiments, the processor 130 may be disposed within a portion 105 of the system 100. For example, the processor 130 may be disposed within the frame such that the processor is disposed centrally, between the sensors 112 and the sensors 114. This may correspond to a location approximately at the nose bridge between the user's eyes when the frame is worn by a user. In other embodiments, the processor 130 may be disposed in other portions of the system 100 (e.g., in the earpiece or stem of the glasses) and/or may be disposed remotely from the system frame. The processor 130 may include hardware and/or software configured to analyze input data from at least the eye-tracking camera system 110, the scene capture camera system 120, and the third camera system 140 to determine the user's gaze direction and/or focus area. In some embodiments (e.g., where the system 100 includes the third camera system 140), data from the third camera system 140 may be synchronized and fused with data from the first camera system 110 and second camera system 120 by the processor 130. This multi-camera approach may provide a more comprehensive understanding of the user's visual focus and the surrounding environment.

In some embodiments, the processor may determine the gaze vector and/or focus area in real-time or near real-time. The processor 130 may utilize advanced algorithms to intelligently interpret signals collected from the multiple eye-tracking sensors 112, 114. These algorithms may be designed to detect minute eye movements and changes in pupil characteristics, such as dilation, which serve as precise indicators of the user's visual attention and eye movement patterns.

In some embodiments, the processor 130 may include embedded artificial intelligence (e.g., machine learning) capabilities that allow the processor to adapt and improve gaze tracking and focus area determination over time. This artificial intelligence capability may lead to increasingly accurate results as the system learns the specific eye movement patterns of a particular user. The processor 130 may be coupled with one or more memory components that store calibration data, configuration settings, application data, captured image data, and/or the like to facilitate retrieval and processing of necessary information.

To handle the intensive computational requirements, the processor 130 may comprise one or more processing cores. In some embodiments, the processor 130 may include a plurality of cores optimized for parallel processing, and for processing of visual data streams in particular. The processor 130 may incorporate one or more hardware accelerators for tasks such as image processing, feature detection, and/or neural network inferencing to enhance real-time performance. The processor 130 may be capable of performing complex operations such as 3D gaze vector calculations, pupillometry analysis, and/or fusion of eye tracking data with scene camera inputs.

The processor 130 may include a communication module that enables real-time data exchange with internal components and/or external devices or systems, such as remote servers or display devices. This feature may allow the processor to transmit visual analytics data and/or receive updates and instructions that enhance the user experience. The communication capabilities may support wired and/or wireless protocols to provide connectivity options.

Power efficiency may be one consideration in the design of the processor 130. In particular, because the processor 130 is integrate into a wearable device, the power source may be relatively small, and users may expect the power source to last for a substantial portion of their waking hours. The processor may optionally incorporate dynamic frequency and/or voltage scaling to optimize power consumption based on current processing demands. The processor 130 may feature dedicated low-power modes for periods of reduced activity to extend battery life of the overall system 100.

### E. A Display Device

In some embodiments, the visual processing system 100 may include a display device 150 configured to present visual information to the user. The display device 150 may be coupled to or integrated with a lens of the system 100 worn by the user.

In some embodiments, the display device 150 may comprise a transparent display that allows the user to see through the display and view the real-world scene. The transparent display may overlay augmented visual information onto the user's view of the real world. This augmented reality configuration enables the system to enhance the user's view with additional digital content while maintaining visibility of the physical environment.

Alternatively, the display device 150 may comprise an opaque display that blocks the user's view of the real scene and presents a fully virtual scene. This virtual reality configuration immerses the user in a computer-generated environment. In some embodiments, the fully virtual scene may include at least a portion of the camera footage captured by the second camera system 120 and/or third camera system 140, allowing the user to perceive the world around them.

In some embodiments, the display device 150 may comprise a mixed reality display that combines aspects of both transparent and opaque displays. The mixed reality display may selectively blend real-world and virtual elements to create a hybrid view for the user.

The display device 150 may be configured to present visual information based on the scene image data captured by the second camera system 120 and the eye tracking data from the first camera system 110. For example, the display 150 may highlight or enhance areas of the scene corresponding to the user's current focus area as determined by the processor 130. The display 150 may present contextual information, notifications, and/or virtual objects aligned with the user's gaze.

In some implementations, the display device 150 may utilize foveated rendering techniques. The foveated rendering may involve presenting high resolution imagery only within the determined gaze point or focus area, while rendering lower resolution imagery in peripheral areas. Foveated rendering can improve system performance and efficiency.

The display device 150 may comprise one or more micro-displays positioned generally in front of the user's eyes. These may include technologies such as liquid crystal displays (LCD), organic light emitting diode (OLED) displays, and/or micro-LED displays. The display device 150 may employ optical elements such as (but not limited to) waveguides and/or combiners to focus the output of the display 150 for comfortable viewing by the user and/or to make one or more added elements in the display appear to be at the same distance as the user's current focus.

The visual processing system 100 may dynamically adjust various display parameters based on the eye tracking data. This may include adapting brightness, contrast, focus, and/or other image characteristics to improve the viewing experience as the user's gaze moves around the scene.

In some embodiments, the display device 150 may be capable of presenting stereoscopic 3D imagery to create a sense of depth. This may be achieved through techniques such as presenting slightly different images to each eye.

The display device 150 may interface with the processor 130 to receive rendered visual content. Alternatively or additionally, a separate graphics processing unit may be employed to handle computationally intensive rendering tasks required for generating complex augmented or virtual imagery in real-time.

The display device 150 serves as the primary visual output for the visual processing system 100, enabling rich interactions between the digital and physical worlds based on the user's natural eye movements and focus. The integration with the eye tracking and scene capture subsystems allows for responsive and contextually relevant visual experiences.

### F. An Illumination System

The visual processing system 100 may include an illumination system 160 configured to provide controlled lighting for at least the eye tracking cameras 112, 114 of the first camera system 110. The illumination system 160 may comprise a plurality of light emitting diodes (LEDs) 162 positioned near the sensors 112, 114 of the first camera system 110. In some embodiments, the LEDs 162 may be configured to emit light in the infrared (IR) spectrum. The IR LEDs may be arranged in a circular pattern surrounding the camera lens to provide uniform illumination of the user's eyes.

The illumination system 160 may utilize multiple IR wavelengths to enhance eye tracking performance. As one non-limiting example, the system 160 may include both 850 nm and 940 nm IR LEDs. The 850 nm LEDs may provide general eye illumination, while the 940 nm LEDs may be optimized for detecting corneal reflections.

The intensity of the IR illumination may be dynamically adjusted based on ambient lighting conditions detected by light sensors in the system 100. This may help maintain consistent eye tracking performance across varying environments.

In some embodiments, the illumination system may include visible light LEDs in addition to IR LEDs. The visible light LEDs may be used to provide visual cues or indicators to the user.

The illumination system may be synchronized with the first camera system 110 to provide pulsed illumination timed with camera exposures. This stroboscopic illumination technique may help reduce motion blur and improve eye tracking accuracy during rapid eye movements.

In some embodiments, beam shaping optics such as lenses and/or diffusers may optionally be used to control the illumination pattern and reduce or minimize stray light. The illumination system 160 may be designed to meet relevant eye safety standards for near-eye IR illumination.

Power management circuitry may be included to efficiently drive the LEDs and extend battery life of the wearable system. The illumination system 160 may be modular to allow easy replacement or upgrades.

The first camera system 110 may utilize the infrared illumination from the illumination system 160 to enhance the detection of eye movement and pupil characteristics in various lighting conditions. This may allow for accurate tracking low-light environments and/or when the user is wearing eyeglasses or contact lenses. The infrared illumination may be pulsed at a high frequency to minimize any potential discomfort to the user while maintaining optimal tracking performance.

### G. An Inertial Monitoring Unit

In some embodiments, the visual processing system 100 may include an inertial monitoring unit (IMU) 170. The IMU 170 may be configured to detect and measure the motion and/or orientation of the system 100. The IMU 170 may comprise one or more accelerometers, gyroscopes, and/or magnetometers to track the device's position, velocity, and/or angular orientation in three-dimensional space.

The accelerometer may measure linear acceleration forces in multiple axes. This may allow the system 100 to detect head movements such as nodding, shaking, and/or tilting. The gyroscope may measure angular velocity to track rotational movements of the head. The magnetometer may act as a compass to provide absolute orientation data relative to the Earth's magnetic field.

By fusing data from these sensors, the IMU 170 may provide accurate information about the user's head pose and movements. This data may be used by the processor 130 to compensate for head motion when determining gaze direction and focus areas. For example, if the user's head turns but their eyes remain fixed on an object, the data from the IMU 170 may allow the system 100 to maintain an accurate estimate of the user's point of focus.

The IMU 170 may enable motion-based gesture controls and/or improve the stability of augmented reality overlays by accounting for head movement. Additionally, data from the IMU 170 may be used to enhance the accuracy of eye tracking by providing context about rapid head motions that could affect pupil position.

The inertial monitoring unit 170 may be integrated into a lens for use with a wearable technology integrating the system 100. The IMU 170 may be in data communication with the processor 130 (e.g., via a digital interface such as 12C or SPI). The IMU 170 may operate at a high sampling rate, potentially 1000 Hz or higher, to capture fine head movements.

In some implementations, data from the IMU 1700 may be fused with visual odometry from the second camera system 120 and/or third camera system 140 to provide even more precise motion tracking. This sensor fusion approach may enable advanced features like simultaneous localization and mapping (SLAM) for improved augmented reality experiences.

The inclusion of an IMU 170 may enhance the overall capabilities of the visual processing system 100 by providing valuable motion data to complement the eye tracking and scene capture functions. This may result in a more robust and responsive system capable of accurately determining user focus and intent across a wide range of head movements and orientations.

### III. PLATFORM OPERATION

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described as being performed by a single computing device, it should be understood that, in some embodiments, different operations may be performed by different networked elements in operative communication with the computing device. For example, at least one computing device 600 may be employed in the performance of some or all of the stages disclosed with regard to the methods. Similarly, an apparatus may be employed in the performance of some or all of the stages of the methods. As such, the apparatus may comprise at least those architectural components found in computing device 600.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the without altering or departing from the fundamental scope of the depicted methods and systems disclosed herein.

### A. Master Method

Consistent with embodiments of the present disclosure, a method may be performed by at least one of the aforementioned modules. The method may be embodied as, for example, but not limited to, computer instructions, which, when executed, perform the method.

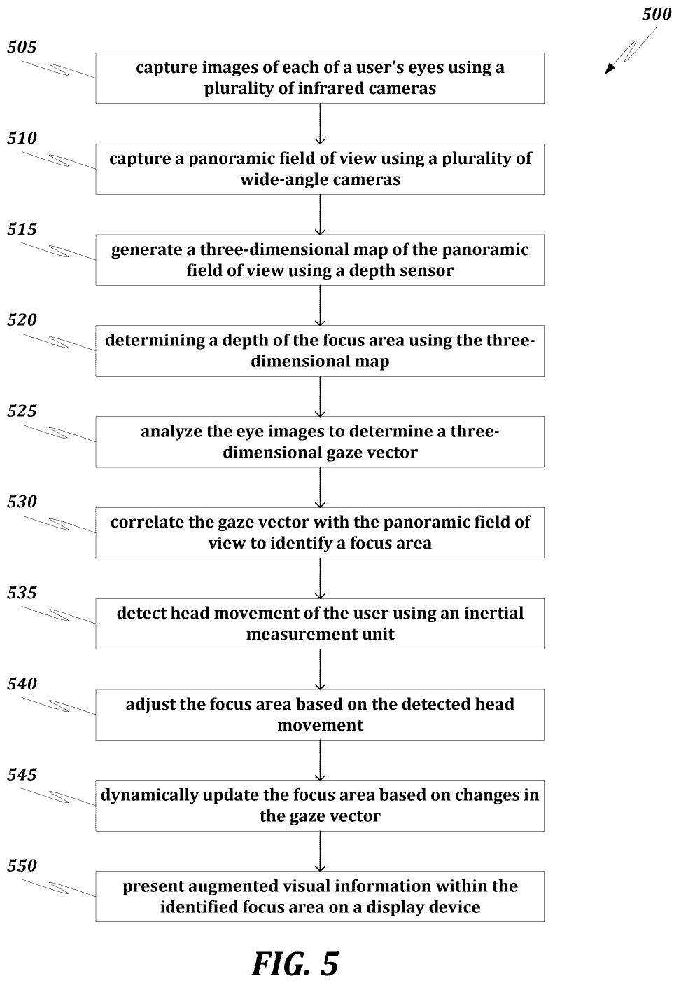

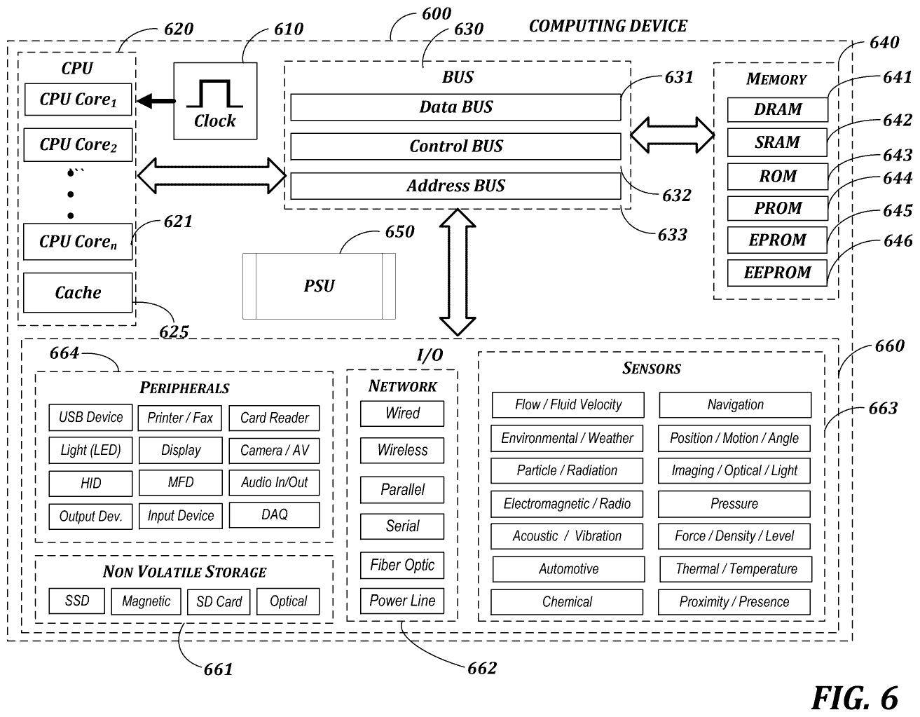

FIG. 5 is a flow chart setting forth the general stages involved in a method 500 consistent with an embodiment of the disclosure for providing visual processing system 100. Method 500 may be implemented using a computing device 600 or any other component associated with platform \hat{ }00 as described in more detail below with respect to FIG. 6. For illustrative purposes alone, computing device 600 is described as one potential actor in the following stages.

Method 500 may begin at stage 505 where cameras may capture images of each of the user's eyes substantially simultaneously. In embodiments, the cameras may be infrared cameras. The infrared cameras may be positioned substantially equidistantly around the central rotation point of each eye to ensure accurate tracking. As one non-limiting example, three infrared cameras may be arranged in a triangular configuration around each eye, with each camera positioned approximately 2 cm from the eye's center of rotation. This arrangement may allow for comprehensive coverage of eye movements and pupil characteristics.

At stage 510, a plurality of wide-angle cameras may capture a panoramic field of view. The captured field of view may exceed 180 degrees horizontally and/or vertically. For instance, four wide-angle cameras with 220-degree lenses may be mounted on the exterior of the wearable frame, positioned to provide overlapping coverage. This configuration may ensure that the entire visual field in front of the user is captured, including peripheral areas beyond the user's natural field of view.

The method may proceed to stage 515, where a three-dimensional map of the captured field of view may be generated. As an example, a depth sensor (e.g., a time-of-flight depth sensor) may be integrated into the wearable frame, emitting infrared light pulses and measuring the time taken for the light to reflect back from objects in the environment. This data may be used to create a detailed 3D representation of the user's surroundings. Additionally or alternatively, distances to objects may be estimated via triangulation where the objects are present in the views from multiple cameras.

At stage 520, the system may analyze the eye images to determine a three-dimensional gaze vector. For instance, the processor may use one or more computer vision algorithms to detect the position and orientation of each eye's pupil and iris. By combining this information from multiple infrared cameras, the system may calculate a precise 3D vector representing the direction of the user's gaze.

The method may continue to stage 525, where the gaze vector may be correlated with the panoramic field of view to identify a focus area. As an example, the processor may use the 3D gaze vector to determine the intersection point with the captured panoramic scene. This intersection point may be identified as the user's focus area, which may be a specific object or region within the field of view. That is, the system may determine a depth of the user's focus area based at least in part on pupil dilation, a comparison of the gaze angles of the users two eyes, and a comparison of the gaze vector with the 3D map of the user's field of view.

At stage 530, an inertial measurement unit may optionally detect head movement of the user. For instance, a six-axis IMU incorporating both an accelerometer and a gyroscope may be integrated into the wearable frame. This sensor may provide data on the linear acceleration and angular velocity of the user's head movements.

The method may proceed to stage 535, where the focus area may be adjusted based on the detected head movement. For example, if the IMU detects that the user has turned their head 30 degrees to the right, the system may adjust the calculated focus area accordingly, ensuring that it remains accurate relative to the user's new head position.

At stage 540, the system may dynamically update the focus area based on changes in the gaze vector and/or the head position of the user. For instance, if the eye tracking system detects that the user's gaze has shifted from one object to another, the focus area may be updated to reflect this change. Likewise, if the IMU determines that the user's head has rotated, the focus area may be adjusted based on the new head position. This real-time or near real-time adjustment may allow for responsive and accurate tracking of the user's visual attention.

The method may continue to stage 545, where augmented visual information may be presented within the identified focus area on a display device. As an example, the system may overlay digital content, such as text labels, 3D models, and/or interactive elements, precisely within the region of the user's focus. In some embodiments, this augmented information may be contextually relevant to what the user is looking at (e.g., an object within the user's focus area). This may utilize computer vision techniques to identify an object within the focus area.

Finally, at stage 550, the augmented visual information may be overlaid onto the user's view of the real world using a transparent display. For instance, a see-through OLED display integrated into the wearable frame may allow the user to view both the physical environment and the digital augmentations simultaneously. The transparency of the display may be adjustable to optimize the blend between real and virtual elements based on ambient lighting conditions and user preferences.

### IV. Hardware Architecture

Embodiments of the present disclosure provide a hardware and software platform operative as a distributed system of modules and computing elements.

System 100 may be embodied as, for example, but not be limited to, a website, a web application, a desktop application, a backend application, and a mobile application compatible with a computing device 600. The computing device 600 may comprise, but not be limited to, the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exascale supercomputer, a mainframe, or a quantum computer;
A minicomputer, wherein the minicomputer computing device comprises, but is not limited to, an IBM AS400/iSeries/System I, A DEC VAX/PDP, an HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack-mounted, a workstation, an industrial device, a raspberry pi, a desktop, or an embedded device;
System 100 may be hosted on a centralized server or a cloud computing service. Although method 500 has been described to be performed by a computing device 600, it should be understood that, in some embodiments, different operations may be performed by a plurality of the computing devices 600 in operative communication on at least one network.

Embodiments of the present disclosure may comprise a system having a central processing unit (CPU) 620, a bus 630, a memory unit 640, a power supply unit (PSU) 650, and one or more Input/Output (I/O) units. The CPU 620 coupled to the memory unit 640 and the plurality of I/O units 660 via the bus 630, all of which are powered by the PSU 650. It should be understood that, in some embodiments, each disclosed unit may actually be a plurality of such units for redundancy, high availability, and/or performance purposes. The combination of the presently disclosed units is configured to perform the stages of any method disclosed herein.

FIG. 6 is a block diagram of a system including computing device 600. Consistent with an embodiment of the disclosure, the aforementioned CPU 620, the bus 630, the memory unit 640, a PSU 650, and the plurality of I/O units 660 may be implemented in a computing device, such as computing device 600 of FIG. 6. Any suitable combination of hardware, software, or firmware may be used to implement the aforementioned units. For example, the CPU 620, the bus 630, and the memory unit 640 may be implemented with computing device 600 or any of other computing devices 600, in combination with computing device 600. The aforementioned system, device, and components are examples and other systems, devices, and components may comprise the aforementioned CPU 620, the bus 630, and the memory unit 640, consistent with embodiments of the disclosure.

At least one computing device 600 may be embodied as any of the computing elements illustrated in all of the attached figures. A computing device 600 does not need to be electronic, nor even have a CPU 620, nor bus 630, nor memory unit 640. The definition of the computing device 600 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 600, especially if the processing is purposeful.

With reference to FIG. 6, a system consistent with an embodiment of the disclosure may include a computing device, such as computing device 600. In some configurations, the computing device 600 may include at least one clock module 610, at least one CPU 620, at least one bus 630, and at least one memory unit 640, at least one PSU 650, and at least one I/O 660 module, wherein I/O module may be comprised of, but not limited to a non-volatile storage sub-module 661, a communication sub-module 662, a sensors sub-module 663, and a peripherals sub-module 664.

In a system consistent with an embodiment of the disclosure, the computing device 600 may include the clock module 610, known to a person having ordinary skill in the art as a clock generator, which produces clock signals. Clock signals may oscillate between a high state and a low state at a controllable rate, and may be used to synchronize or coordinate actions of digital circuits. Most integrated circuits (ICs) of sufficient complexity use a clock signal in order to synchronize different parts of the circuit, cycling at a rate slower than the worst-case internal propagation delays. One well-known example of the aforementioned integrated circuit is the CPU 620, the central component of modern computers, which relies on a clock signal. The clock 610 can comprise a plurality of embodiments, such as, but not limited to, a single-phase clock which transmits all clock signals on effectively 1 wire, a two-phase clock which distributes clock signals on two wires, each with non-overlapping pulses, and a four-phase clock which distributes clock signals on 4 wires.

Many computing devices 600 may use a “clock multiplier” which multiplies a lower frequency external clock to the appropriate clock rate of the CPU 620. This allows the CPU 620 to operate at a much higher frequency than the rest of the computing device 600, which affords performance gains in situations where the CPU 620 does not need to wait on an external factor (like memory 640 or input/output 660). Some embodiments of the clock 610 may include dynamic frequency change, where the time between clock edges can vary widely from one edge to the next and back again.

In a system consistent with an embodiment of the disclosure, the computing device 600 may include the CPU 620 comprising at least one CPU Core 621. In other embodiments, the CPU 620 may include a plurality of identical CPU cores 621, such as, but not limited to, homogeneous multi-core systems. It is also possible for the plurality of CPU cores 621 to comprise different CPU cores 621, such as, but not limited to, heterogeneous multi-core systems, big.LITTLE systems and some AMD accelerated processing units (APU). The CPU 620 reads and executes program instructions which may be used across many application domains, for example, but not limited to, general purpose computing, embedded computing, network computing, digital signal processing (DSP), and graphics processing (GPU). The CPU 620 may run multiple instructions on separate CPU cores 621 simultaneously. The CPU 620 may be integrated into at least one of a single integrated circuit die, and multiple dies in a single chip package. The single integrated circuit die and/or the multiple dies in a single chip package may contain a plurality of other elements of the computing device 600, for example, but not limited to, the clock 610, the bus 630, the memory 640, and I/O 660.

The CPU 620 may contain cache 622 such as but not limited to a level 1 cache, a level 2 cache, a level 3 cache, or combinations thereof. The cache 622 may or may not be shared amongst a plurality of CPU cores 621. The cache 622 sharing may comprise at least one of message passing and inter-core communication methods used for the at least one CPU Core 621 to communicate with the cache 622. The inter-core communication methods may comprise, but not be limited to, bus, ring, two-dimensional mesh, and crossbar. The aforementioned CPU 620 may employ symmetric multiprocessing (SMP) design.

The one or more CPU cores 621 may comprise soft microprocessor cores on a single field programmable gate array (FPGA), such as semiconductor intellectual property cores (IP Core). The architectures of the one or more CPU cores 621 may be based on at least one of, but not limited to, Complex Instruction Set Computing (CISC), Zero Instruction Set Computing (ZISC), and Reduced Instruction Set Computing (RISC). At least one performance-enhancing method may be employed by one or more of the CPU cores 621, for example, but not limited to Instruction-level parallelism (ILP) such as, but not limited to, superscalar pipelining, and Thread-level parallelism (TLP).

Consistent with the embodiments of the present disclosure, the aforementioned computing device 600 may employ a communication system that transfers data between components inside the computing device 600, and/or the plurality of computing devices 600. The aforementioned communication system will be known to a person having ordinary skill in the art as a bus 630. The bus 630 may embody internal and/or external hardware and software components, for example, but not limited to a wire, an optical fiber, various communication protocols, and/or any physical arrangement that provides the same logical function as a parallel electrical bus. The bus 630 may comprise at least one of a parallel bus, wherein the parallel bus carries data words in parallel on multiple wires; and a serial bus, wherein the serial bus carries data in bit-wise serial form. The bus 630 may embody a plurality of topologies, for example, but not limited to, a multidrop/electrical parallel topology, a daisy chain topology, and connected by switched hubs, such as a USB bus. The bus 630 may comprise a plurality of embodiments, for example, but not limited to:
Internal data bus (data bus) 631/Memory bus
Control bus 632
Address bus 633
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu}Link]), Express Card, AdvancedTCA, AMC, Universal 10, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and eXtensible Host Controller Interface (xHCI).

Consistent with the embodiments of the present disclosure, the aforementioned computing device 600 may employ hardware integrated circuits that store information for immediate use in the computing device 600, known to persons having ordinary skill in the art as primary storage or memory 640. The memory 640 operates at high speed, distinguishing it from the non-volatile storage sub-module 661, which may be referred to as secondary or tertiary storage, which provides relatively slower-access to information but offers higher storage capacity. The data contained in memory 640, may be transferred to secondary storage via techniques such as, but not limited to, virtual memory and swap. The memory 640 may be associated with addressable semiconductor memory, such as integrated circuits consisting of silicon-based transistors, that may be used as primary storage or for other purposes in the computing device 600. The memory 640 may comprise a plurality of embodiments, such as, but not limited to volatile memory, non-volatile memory, and semi-volatile memory. It should be understood by a person having ordinary skill in the art that the following are non-limiting examples of the aforementioned memory:
Volatile memory, which requires power to maintain stored information, for example, but not limited to, Dynamic Random-Access Memory (DRAM) 641, Static Random-Access Memory (SRAM) 642, CPU Cache memory 625, Advanced Random-Access Memory (A-RAM), and other types of primary storage such as Random-Access Memory (RAM).
Non-volatile memory, which can retain stored information even after power is removed, for example, but not limited to, Read-Only Memory (ROM) 643, Programmable ROM (PROM) 644, Erasable PROM (EPROM) 645, Electrically Erasable PROM (EEPROM) 646 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory may have limited non-volatile duration after power is removed but may lose data after said duration has passed. Semi-volatile memory provides high performance, durability, and other valuable characteristics typically associated with volatile memory, while providing some benefits of true non-volatile memory. The semi-volatile memory may comprise volatile and non-volatile memory, and/or volatile memory with a battery to provide power after power is removed. The semi-volatile memory may comprise, but is not limited to, spin-transfer torque RAM (STT-RAM).

Consistent with the embodiments of the present disclosure, the aforementioned computing device 600 may employ a communication system between an information processing system, such as the computing device 600, and the outside world, for example, but not limited to, human, environment, and another computing device 600. The aforementioned communication system may be known to a person having ordinary skill in the art as an Input/Output (I/O) module 660. The I/O module 660 regulates a plurality of inputs and outputs with regard to the computing device 600, wherein the inputs are a plurality of signals and data received by the computing device 600, and the outputs are the plurality of signals and data sent from the computing device 600. The I/O module 660 interfaces with a plurality of hardware, such as, but not limited to, non-volatile storage 661, communication devices 662, sensors 663, and peripherals 664. The plurality of hardware is used by at least one of, but not limited to, humans, the environment, and another computing device 600 to communicate with the present computing device 600. The I/O module 660 may comprise a plurality of forms, for example, but not limited to channel I/O, port mapped I/O, asynchronous I/O, and Direct Memory Access (DMA).

Consistent with the embodiments of the present disclosure, the aforementioned computing device 600 may employ a non-volatile storage sub-module 661, which may be referred to by a person having ordinary skill in the art as one of secondary storage, external memory, tertiary storage, off-line storage, and auxiliary storage. The non-volatile storage sub-module 661 may not be accessed directly by the CPU 620 without using an intermediate area in the memory 640. The non-volatile storage sub-module 661 may not lose data when power is removed and may be orders of magnitude less costly than storage used in memory 640. Further, the non-volatile storage sub-module 661 may have a slower speed and higher latency than in other areas of the computing device 600. The non-volatile storage sub-module 661 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (661) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the computing device 600 may employ a communication sub-module 662 as a subset of the I/O module 660, which may be referred to by a person having ordinary skill in the art as at least one of, but not limited to, a computer network, a data network, and a network. The network may allow computing devices 600 to exchange data using connections, which may also be known to a person having ordinary skill in the art as data links, which may include data links between network nodes. The nodes may comprise networked computer devices 600 that may be configured to originate, route, and/or terminate data. The nodes may be identified by network addresses and may include a plurality of hosts consistent with the embodiments of a computing device 600. Examples of computing devices that may include a communication sub-module 662 include, but are not limited to, personal computers, phones, servers, drones, and networking devices such as, but not limited to, hubs, switches, routers, modems, and firewalls.

Two nodes can be considered networked together when one computing device 600 can exchange information with the other computing device 600, regardless of any direct connection between the two computing devices 600. The communication sub-module 662 supports a plurality of applications and services, such as, but not limited to World Wide Web (WWW), digital video and audio, shared use of application and storage computing devices 600, printers/scanners/fax machines, email/online chat/instant messaging, remote control, distributed computing, etc. The network may comprise one or more transmission mediums, such as, but not limited to conductive wire, fiber optics, and wireless signals. The network may comprise one or more communications protocols to organize network traffic, wherein application-specific communications protocols may be layered, and may be known to a person having ordinary skill in the art as being improved for carrying a specific type of payload, when compared with other more general communications protocols. The plurality of communications protocols may comprise, but are not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], Integrated Digital Enhanced Network [IDEN], Long Term Evolution [LTE], LTE-Advanced [LTE-A], and fifth generation [5G] communication protocols).

The communication sub-module 662 may comprise a plurality of size, topology, traffic control mechanisms and organizational intent policies. The communication sub-module 662 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 4G (such as WiMAX and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus networks such as Ethernet, star networks such as Wi-Fi, ring networks, mesh networks, fully connected networks, and tree networks. The network can be characterized by its physical capacity or its organizational purpose. Use of the network, including user authorization and access rights, may differ according to the layout of the network. The characterization may include, but is not limited to a nanoscale network, a Personal Area Network (PAN), a Local Area Network (LAN), a Home Area Network (HAN), a Storage Area Network (SAN), a Campus Area Network (CAN), a backbone network, a Metropolitan Area Network (MAN), a Wide Area Network (WAN), an enterprise private network, a Virtual Private Network (VPN), and a Global Area Network (GAN).

Consistent with the embodiments of the present disclosure, the aforementioned computing device 600 may employ a sensors sub-module 663 as a subset of the I/O 660. The sensors sub-module 663 comprises at least one of the device, module, or subsystem whose purpose is to detect events or changes in its environment and send the information to the computing device 600. Sensors may be sensitive to the property they are configured to measure, may not be sensitive to any property not measured but be encountered in its application, and may not significantly influence the measured property. The sensors sub-module 663 may comprise a plurality of digital devices and analog devices, wherein if an analog device is used, an Analog to Digital (A-to-D) converter must be employed to interface the said device with the computing device 600. The sensors may be subject to a plurality of deviations that limit sensor accuracy. The sensors sub-module 663 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensors such as a guitar pickup, seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, moisture alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, airspeed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as but not limited to, accelerometer, displacement sensor, flex sensor, free-fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED configured as a light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 600 may employ a peripherals sub-module 664 as a subset of the I/O 660. The peripheral sub-module 664 comprises ancillary devices uses to put information into and get information out of the computing device 600. There are 3 categories of devices comprising the peripheral sub-module 664, which exist based on their relationship with the computing device 600, input devices, output devices, and input/output devices. Input devices send at least one of data and instructions to the computing device 600. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to the position of a mouse.
The number of degrees of freedom involved, such as, but not limited to, two-dimensional mice and three-dimensional mice used for Computer-Aided Design (CAD) applications.

Output devices provide output from the computing device 600. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 664:
Input Devices
   Human Interface Devices (HID), such as, but not limited to, pointing device (e.g., mouse, touchpad, joystick, touchscreen, game controller/gamepad, remote, light pen, light gun, infrared remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 600. The information can be stored in a multitude of formats depending on the user's requirement. Examples of types of video input devices include, but are not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device to capture produced sound. Audio input devices allow a user to send audio signals to the computing device 600 for at least one of processing, recording, and carrying out commands. Devices such as microphones allow users to speak to the computer to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 600. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices may convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers, and plotters.
   Audio and Video (AV) devices, such as, but not limited to, speakers, headphones, amplifiers, and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking devices (e.g., devices disclosed in network sub-module 662), data storage devices (non-volatile storage 661), facsimile (FAX), and graphics/sound cards.

All rights, including copyrights in the code included herein, are vested in and the property of the Applicant. The Applicant retains and reserves all rights in the code included herein, and grants permission to reproduce the material only in connection with the reproduction of the granted patent and for no other purpose.

### V. ASPECTS

The following discloses various Aspects of the present disclosure. The various Aspects are not to be construed as patent claims unless the language of the Aspect appears as a patent claim. The Aspects describe various non-limiting embodiments of the present disclosure.

Aspect 1. A visual processing system, comprising:
a first camera system configured to monitor eye movement and pupil characteristics of a user;
a second camera system configured to capture an external field of view; and
a processor configured to determine a focus area within an external field of view based on monitored eye movement.

Aspect 2. The system of Aspect 1, wherein the first camera system includes at least two eye-tracking (ET) sensors for each eye of the user.

Aspect 3. The system of Aspect 2, wherein the ET sensors are positioned equidistant to a central rotation point of the corresponding eye.

Aspect 4. The system of Aspect 1, wherein the second camera system includes at least one scene camera angled to align with the central rotation point of the user's eyes.

Aspect 5. The system of Aspect 4, wherein the lens of the scene camera is configured to capture a field of view wider than the full field of view of each eye of the user.

Aspect 6. The system of Aspect 1, further comprising a third camera system positioned at approximately the user's eye level (e.g., at eye level, just below eye level, just above eye level) to enhance depth perception and point of gaze detection accuracy within the captured field of view.

Aspect 7. The system of Aspect 1, wherein the first camera system and the second camera system are integrated into a lens configured for use with a housing.

Aspect 8. The system of Aspect 7, wherein the lens is capable of attaching on or in various harnesses, glasses frames, and/or helmets.

Aspect 9. The system of Aspect 7, wherein data collection and synchronization elements are disposed separately from the lens and in wired communication with one or more of the components embedded in the lens.

Aspect 10. The system of Aspect 9, further comprising a central capture/relay point located at the front center of the housing visor for data processing.

Aspect 11. The system of Aspect 7, wherein the system comprises a battery in electrical communication with the lens.

Aspect 12. The system of Aspect 1, wherein the processor is further configured to adjust the focus area in real-time based on dynamic changes in the user's eye movement.

Aspect 13. The system of Aspect 1, wherein the first camera system is capable of capturing stereoscopic images of the user's eyes for improved eye movement tracking.

Aspect 14. The system of Aspect 1, wherein the second camera system includes a plurality of scene cameras, each paired with a corresponding set of ET sensors.

Aspect 15. The system of Aspect 14, wherein the plurality of scene cameras are configured to capture overlapping images to provide a comprehensive field of view.

Aspect 16. The system of Aspect 1, wherein the ET sensors are capable of detecting both eye movement and pupil dilation to enhance the accuracy of focus area determination.

Aspect 17. A dual monocular system, comprising:
a first camera system including one or more cameras positioned on the interior side of a lens, configured to capture images of a user's eyes; and
a second camera system including one or more cameras positioned on the exterior side of the lens, configured to capture a panoramic field of view in front of the user.

Aspect 18. The system of Aspect 17, wherein the first camera system is configured to detect eye movement and pupil characteristics, including dilation.

Aspect 19. The system of Aspect 17, wherein the second camera system is configured to capture a scene image or video image with approximately 114 degrees (and up to 180 degrees or more) of coverage in the X and/or Y planes.

Aspect 20. The system of Aspect 19, wherein the second camera system includes an overlap region of approximately 48 degrees to ensure comprehensive visual information capture.

Aspect 21. The system of Aspect 17, wherein the first camera system comprises a plurality of cameras for each eye to provide stereoscopic monitoring of the user's eyes.

Aspect 22. The system of Aspect 17, wherein the second camera system comprises multiple cameras arranged to collectively provide the panoramic field of view.

Aspect 23. The system of Aspect 22, wherein each camera of the second camera system is equipped with a wide-angle lens to facilitate the panoramic capture.

Aspect 24. The system of Aspect 17, further comprising a processing unit configured to correlate the eye movement data from the first camera system with the field of view data from the second camera system.

Aspect 25. The system of Aspect 24, wherein the processing unit is configured to identify a specific area within the panoramic field of view that corresponds to the user's gaze.

Aspect 26. The system of Aspect 17, wherein the lens is designed to maintain the cameras of the first and second systems in fixed strategic positions relative to the user's eyes and the scene, respectively.

Aspect 27. The system of Aspect 17, wherein the first camera system utilizes infrared illumination to enhance the detection of eye movement and pupil characteristics in various lighting conditions.

Aspect 28. The system of Aspect 17, wherein the second camera system is configured to capture high-resolution images to provide detailed scene information.

Aspect 29. The system of Aspect 17, wherein the first camera system includes cameras capable of capturing images at a high frame rate to accurately track rapid eye movements.

Aspect 30. The system of Aspect 17, wherein the second camera system includes image stabilization features to ensure clear image capture while the user is in motion.

Aspect 31. The system of Aspect 17, wherein the first camera system includes at least one camera per eye, each camera positioned to capture a full image of the eye's iris and pupil.

Aspect 32. The system of Aspect 17, wherein the second camera system includes cameras that are adjustable to accommodate different user preferences for field of view coverage.

Aspect 33. The system of Aspect 17, wherein the first camera system includes cameras with autofocus capabilities to maintain clear images of the user's eyes despite movement.

Aspect 34. The system of Aspect 17, wherein the second camera system includes cameras with high dynamic range (HDR) capabilities to capture clear scene images under varying lighting conditions.

Aspect 35. The system of Aspect 17, wherein the first camera system includes cameras with filters to reduce glare and improve the accuracy of eye movement detection.

Aspect 36. The system of Aspect 17, wherein the second camera system includes cameras capable of capturing three-dimensional (3D) scene data to provide depth information in the captured field of view.

Aspect 37. A dual monocular system, comprising:
a first camera system including a plurality of cameras mounted on the interior side of a wearable lens, each camera configured to monitor eye movement and pupil characteristics of a user;
a second camera system including a plurality of cameras mounted on the exterior side of the wearable lens, each camera configured to capture a portion of a field of view in front of the user, the combined field of view of the cameras encompassing approximately 180 degrees in the X and Y planes with an overlap region; and
a processor configured to analyze data from the first camera system to determine a focus area within the field of view captured by the second camera system.

Aspect 38. The dual monocular system of Aspect 37, wherein the first camera system is configured to capture a stereoscopic image of the user's eye to enhance depth perception and eye movement tracking.

Aspect 39. The dual monocular system of Aspect 37, further comprising a third camera system positioned at approximately eye level (e.g., at eye level, just below eye level, or just above eye level) to provide additional depth information within the captured field of view.

Aspect 40. The dual monocular system of Aspect 37, wherein the processor is further configured to adjust the focus area in real-time based on dynamic changes in the user's eye movement.

Aspect 41. The dual monocular system of Aspect 37, wherein the wearable lens is designed to minimize obstruction of the user's field of view.

Aspect 42. The dual monocular system of Aspect 37, wherein the second camera system is configured to capture high-definition video images.

Aspect 43. The dual monocular system of Aspect 37, wherein the wearable lens is configured to be attached to any of a variety of harnesses, glasses and/or helmets.

Aspect 44. The dual monocular system of Aspect 37, wherein the first camera system includes cameras with autofocus capabilities to maintain clear images of the user's eyes despite movement.

Aspect 45. The dual monocular system of Aspect 37, wherein the second camera system includes cameras with high dynamic range (HDR) capabilities to capture clear scene images under varying lighting conditions.

Aspect 46. The dual monocular system of Aspect 37, wherein the first camera system includes cameras with filters to reduce glare and improve the accuracy of eye movement detection.

Aspect 47. The dual monocular system of Aspect 37, wherein the second camera system includes cameras capable of capturing three-dimensional (3D) scene data to provide depth information in the captured field of view.

Aspect 48. The dual monocular system of Aspect 37, wherein the first camera system includes at least one camera per eye, each camera positioned to capture a full image of the eye's iris and pupil through the full range of movement.

Aspect 49. The dual monocular system of Aspect 37, wherein the second camera system includes cameras that are adjustable to accommodate different user preferences for field of view coverage.

Aspect 50. The dual monocular system of Aspect 37, wherein the first camera system includes cameras capable of capturing images at a high frame rate to accurately track rapid eye movements.

Aspect 51. The dual monocular system of Aspect 37, wherein the second camera system includes image stabilization features to ensure clear image capture while the user is in motion.

Aspect 52. The dual monocular system of Aspect 37, wherein the processor is further configured to use machine learning algorithms to improve the accuracy of focus area determination over time.

Aspect 53. A head-mounted visual capture device, comprising:
an eye-tracking system including a plurality of eye-tracking sensors for each eye of a user, each sensor positioned equidistant to a central rotation point of the corresponding eye;
a scene camera system including at least one camera angled toward a center of eye rotational capabilities and having a lens width exceeding a full field of view of the user; and
a data synchronization module configured to integrate inputs from the eye-tracking system and the scene camera system.

Aspect 54. The head-mounted visual capture device of Aspect 53, wherein the eye-tracking sensors are infrared sensors capable of detecting subtle movements of the user's pupils.

Aspect 55. The head-mounted visual capture device of Aspect 53, further comprising a central capture/relay point in data communication with a wearable lens for enhanced data processing.

Aspect 56. The head-mounted visual capture device of Aspect 53, wherein the scene camera system includes a third camera to provide redundancy and improve scene image accuracy.

Aspect 57. The head-mounted visual capture device of Aspect 53, wherein the scene camera system includes a fourth camera to provide additional coverage and improve scene depth estimation.

Aspect 58. The head-mounted visual capture device of Aspect 53, wherein the eye tracking system of cameras is configured to capture stereoscopic images of the user's eyes.

Aspect 59. The head-mounted visual capture device of Aspect 55, wherein the central capture/relay point comprises a processor, a memory, a communication module, and a power supply.

Aspect 60. The head-mounted visual capture device of Aspect 59, wherein the processor is configured to perform image processing, eye tracking, gaze estimation, and data transmission.

Aspect 61. The head-mounted visual capture device of Aspect 59, wherein the memory is configured to store image data, calibration data, configuration data, and application data.

Aspect 62. The head-mounted visual capture device of Aspect 59, wherein the communication module is configured to communicate with a remote server, a display device, or another head-mounted visual capture device.

Aspect 63. The head-mounted visual capture device of Aspect 59, wherein the power supply is configured to provide power to the scene camera system and the central capture/relay point.

Aspect 64. The head-mounted visual capture device of Aspect 53, further comprising a display device coupled to the housing visor, wherein the display device is configured to present visual information to the user based on the scene image data and the eye image data.

Aspect 65. The head-mounted visual capture device of Aspect 64, wherein the display device is a transparent display that allows the user to see through the display device and view the real scene.

Aspect 66. The head-mounted visual capture device of Aspect 64, wherein the display device is an opaque display that blocks the user's view of the real scene and presents a virtual scene.

Aspect 67. The head-mounted visual capture device of Aspect 64, wherein the display device is a mixed reality display that combines the real scene and the virtual scene.

Aspect 68. The head-mounted visual capture device of Aspect 53, further comprising a user input module coupled to the housing visor, wherein the user input module is configured to receive user commands or gestures and control the operation of the head-mounted visual capture device.

Aspect 69. The head-mounted visual capture device of Aspect 68, wherein the user input module comprises one or more of a microphone, a speaker, a touchpad, a button, a joystick, a motion sensor, or a gesture sensor.

Aspect 70. The head-mounted visual capture device of Aspect 69, further comprising a remote server configured to receive the scene image data and the eye image data from the central capture/relay point, process the data, and provide feedback or instructions to the head-mounted visual capture device.

Aspect 71. The head-mounted visual capture device of Aspect 70, wherein the remote server is configured to perform one or more of image analysis, object recognition, scene understanding, face recognition, emotion detection, attention analysis, or gaze-based interaction.

Aspect 72. The head-mounted visual capture device of Aspect 70, wherein the feedback or instructions from the remote server are presented to the user via the display device or the user input module.

Aspect 73. The head-mounted visual capture device of Aspect 53, wherein the head-mounted visual capture device is used for one or more of augmented reality, virtual reality, mixed reality, gaming, entertainment, education, training, navigation, communication, social media, e-commerce, advertising, security, surveillance, health care, computer operation, machine operation, or eye tracking.

Aspect 74. The head-mounted visual capture device of Aspect 53, wherein the housing visor is adjustable to fit different sizes and shapes of user heads.

Aspect 75. The head-mounted visual capture device of Aspect 53, wherein the scene camera system, the second system of cameras, and the central capture/relay point are integrated into the housing visor or detachable from the housing visor.

### VI. CLAIMS

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A visual processing system, comprising:
a first camera system comprising a plurality of infrared cameras configured to capture images of a user's eyes;
a second camera system comprising a plurality of wide-angle cameras configured to capture a panoramic field of view exceeding 180 degrees horizontally and vertically;
a processor configured to:
analyze the eye images to determine a three-dimensional gaze vector,
correlate the gaze vector with the panoramic field of view to identify a focus area, and
dynamically update the focus area based on changes in the gaze vector; and
a display device configured to present augmented visual information within the identified focus area.

2. The system of claim 1, wherein the first camera system comprises at least three infrared cameras per eye, positioned equidistant around a central rotation point of each eye.

3. The system of claim 1, wherein the second camera system comprises at least two wide-angle cameras arranged to provide overlapping fields of view.

4. The system of claim 1, further comprising an inertial measurement unit configured to detect head movement of the user.

5. The system of claim 4, wherein the processor is further configured to adjust the focus area based on the detected head movement.

6. The system of claim 1, further comprising a depth sensor configured to generate a three-dimensional map of the panoramic field of view.

7. The system of claim 6, wherein the processor is further configured to determine a depth of the focus area using the three-dimensional map.

8. The system of claim 1, wherein the display device comprises a transparent display configured to overlay the augmented visual information onto the user's view of the real world.

9. A visual processing system, comprising:
a first camera system comprising a plurality of high-speed cameras configured to capture images of a user's eyes at a frame rate of at least 180 frames per second;
a second camera system comprising a plurality of cameras with fish-eye lenses configured to capture a spherical field of view;
an illumination system configured to project structured light patterns onto the user's eyes;
a processor configured to:
analyze the high-speed eye images and structured light patterns to construct a three-dimensional model of each eye's movements and deformations,
map the three-dimensional eye model to the spherical field of view to determine a precise gaze point and focal depth, and
track micro-saccades and subtle eye movements to infer user intent; and
a low-latency display system configured to present context-aware information at the determined gaze point with depth-appropriate focus.

10. The system of claim 9, wherein the first camera system comprises at least four high-speed cameras per eye, positioned to capture the entire visible surface of each eye.

11. The system of claim 9, wherein the second camera system comprises at least six fish-eye cameras arranged to provide a full 360-degree spherical view around the user's head.

12. The system of claim 9, further comprising a neural processing unit configured to apply machine learning algorithms to the eye movement data to predict user attention patterns.

13. The system of claim 9, wherein the illumination system comprises a plurality of infrared light-emitting diodes configured to project different structured light patterns in rapid succession.

14. The system of claim 9, wherein the processor is further configured to analyze eyelid movements and blink patterns to infer user fatigue levels.

15. The system of claim 9, wherein the low-latency display system comprises a foveated rendering engine configured to present high-resolution imagery only within the determined gaze point and lower resolution imagery in peripheral areas.

16. A visual processing system, comprising:
a first camera system configured to be mounted on an interior portion of a wearable visor, comprising:
at least three infrared cameras per eye positioned equidistantly around each eye's central rotation point, and
at least one high-speed camera per eye configured to capture images at approximately 180 frames per second;
a second camera system configured to be mounted on an exterior portion of the wearable frame, comprising:
at least four wide-angle cameras arranged to capture a 360-degree spherical field of view, and
at least one depth-sensing camera;
a processor configured to:
construct a three-dimensional model of each eye's position, rotation, and deformation based on data from the first camera system,
generate a high-resolution, three-dimensional environmental model based on data from the second camera system,
determine a gaze vector and focal depth by mapping the eye model to the environmental model,
track micro-saccades and pupil dilation to infer user intent and cognitive load, and
dynamically update the gaze vector and focal depth in real-time; and
a see-through display integrated into the frame, configured to present context-aware augmented reality content at the determined gaze vector and focal depth.

17. The system of claim 16, further comprising an eye illumination system configured to project structured light patterns onto the user's eyes, wherein the processor is further configured to analyze distortions in the structured light patterns to enhance the three-dimensional eye model.

18. The system of claim 16, wherein the processor comprises a neural processing unit configured to apply machine learning algorithms to historical eye-tracking data to predict future gaze patterns and pre-render augmented reality content.

19. The system of claim 16, further comprising an inertial measurement unit, wherein the processor is further configured to use data from the inertial measurement unit to compensate for head movements when determining the gaze vector.

20. The system of claim 16, wherein the see-through display comprises a foveated display system configured to present high-resolution imagery within a 5-degree radius of the determined gaze vector and progressively lower resolution imagery in peripheral areas.

21. A method of visual processing, comprising:
capturing stereoscopic images of a user's eyes using a plurality of infrared cameras;
capturing a panoramic field of view exceeding 180 degrees horizontally and vertically using a plurality of wide-angle cameras;
analyzing the stereoscopic eye images to determine a three-dimensional gaze vector;
correlating the gaze vector with the panoramic field of view to identify a focus area;
dynamically updating the focus area based on changes in the gaze vector; and
presenting augmented visual information within the identified focus area on a display device.

22. The method of claim 21, further comprising:
detecting head movement of the user using an inertial measurement unit; and
adjusting the focus area based on the detected head movement.

23. The method of claim 21, further comprising:
generating a three-dimensional map of the panoramic field of view using a depth sensor; and
determining a depth of the focus area using the three-dimensional map.

24. The method of claim 21, wherein capturing stereoscopic images of the user's eyes comprises:
positioning at least three infrared cameras per eye equidistant around a central rotation point of each eye; and
capturing images from the infrared cameras simultaneously to generate the stereoscopic images.

25. The method of claim 21, wherein presenting augmented visual information comprises:
overlaying the augmented visual information onto the user's view of the real world using a transparent display.
